(19) United States
(12) Patent Application Publication
(10) Pub. No.: US 2021/0035570 A1
(43) Pub. Date: Feb. 4, 2021

(54) Clarification for Personal Assistants in Noisy Environments

(71) Applicant: Motorola Mobility LLC, Chicago, IL (US)

(72) Inventors: Amit Kumar Agrawal, Bangalore (IN); Andre Luiz Silva Bazante, Campinas (BR); Olivier David Meirhaeghe, Lincolnshire, IL (US); Robert S. Witte, Algonquin, IL (US)

(73) Assignee: Motorola Mobility LLC, Chicago, IL (US)

(21) Appl. No.: 16/525,401

(22) Filed: Jul. 29, 2019

(51) Int. Cl. G10L 15/20; G10L 15/22; G10L 25/84; G10L 15/30

(52) U.S. Cl. CPC G10L 15/20; G10L 15/30; G10L 25/84; G10L 15/22

(57) ABSTRACT

Various embodiments receive, by a personal assistant embodied on a computing device, a verbal instruction. The personal assistant ascertains whether the verbal instruction is intact. Responsive to the verbal instruction not being received intact, noise in an ambient environment around the computing device is monitored and responsive to the noise in the ambient environment being below a noise threshold, clarification of the verbal instruction is requested.

### BACKGROUND

Automated personal assistants are becoming increasingly more popular over time. Personal assistants typically work by receiving spoken input and, responsively, performing some task. For example, a user may activate a personal assistant on their phone and inquire about the nearest pizza shop. Typically, the personal assistant will ascertain the user's location from a location aware module on the device, perform an Internet search based on the user's query, and return the information to the user.

However, in noisy environments a personal assistant may not necessarily understand what the user has said. Alternately, a personal assistant may only understand a portion of what the user has said. Accordingly, such noisy environments can lead to erroneous results and can significantly degrade the user's experience.

### BRIEF DESCRIPTION OF THE DRAWINGS

Embodiments for disambiguation and clarification for personal assistants in noisy environments are described with reference to the following Figures. The same numbers may be used throughout to reference like features and components that are shown in the Figures:

FIG. 1 illustrates an example operating environment in accordance with one or more embodiments;

FIG. 2 illustrates an example personal assistant in accordance with one or more embodiments;

FIG. 3 illustrates an example personal assistant in accordance with one or more embodiments;

FIG. 4 is a flow diagram that illustrates operations in accordance with one or more embodiments;

FIG. 5 is a flow diagram that illustrates operations in accordance with one or more embodiments; and

FIG. 6 illustrates various components of an example device that can implement various embodiments.

### DETAILED DESCRIPTION

### Overview

Various embodiments enable disambiguation and clarification for personal assistants in noisy environments. In various embodiments, when a personal assistant is in a noisy environment and a user attempts to provide a verbal instruction, the personal assistant is able to process the verbal instruction and/or the context associated with provision of the verbal instruction, and ascertain whether the verbal instruction was received intact or whether the noisy environment prevented some or all of the verbal instruction from being understood by the personal assistant. In an event that some or all of the verbal instruction was not understood by the personal assistant, the personal assistant is configured to wait until the noise in the environment abates to a level that is more suitable for fully understanding the verbal instruction. The personal assistant optionally provides a user-perceptible indication that indicates that the environment is noisy (or that the personal assistant is “paused” because of the noisy environment), such as an LED light, a visual display or message, an audible message, an alert tone, a flag, haptic feedback, and so forth. This user-perceptible indication notifies the user that the likelihood of receiving an intact verbal instruction is low and thus that the personal assistant is “paused”, allowing the user to, for example, wait until the perceptible indication is removed so that the verbal instruction can be provided or find a quieter location in which to provide the verbal instruction. When the noise abates, any such user-perceptible indication that the personal assistant is “paused” is removed, and the personal assistant can then ask for clarification by requesting, for example, that the user repeat the instruction.

In this mariner, the personal assistant is able to disambiguate and clarify verbal instructions when such instructions are provided in a noisy environment.

While features and concepts for disambiguation and clarification for personal assistants in noisy environments can be implemented in any number of different devices, systems, environments, and/or configurations, embodiments for disambiguation and clarification for personal assistants in noisy environments are described in the context of the following example devices, systems, and methods.

### Example Operating Environment

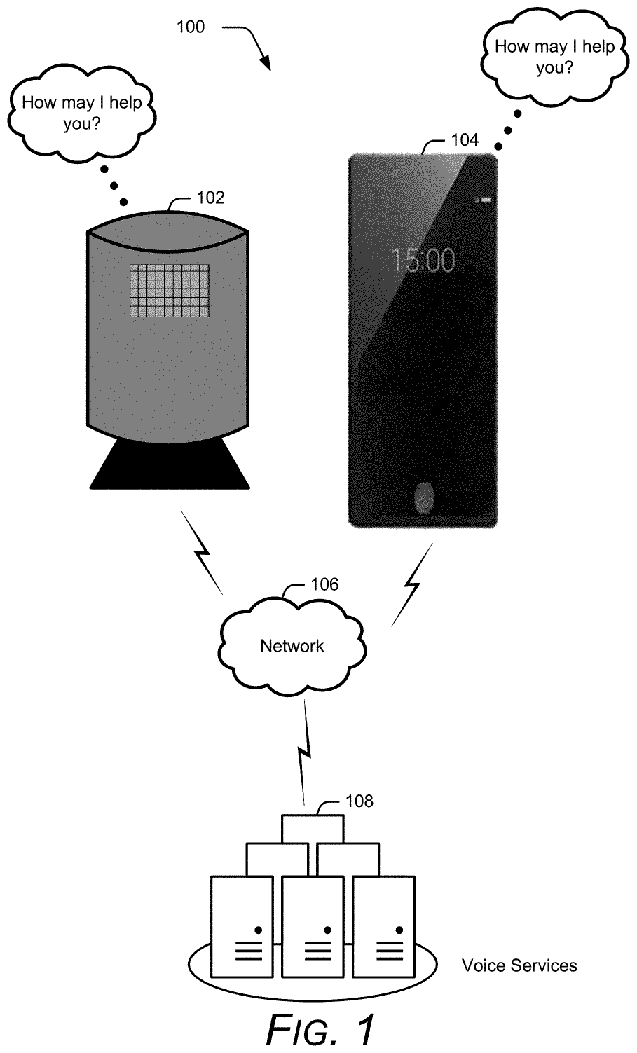

FIG. 1 illustrates example environment 100 according to one or more embodiments. Environment 100 includes two different types of personal assistants 102, 104. Personal assistant 102 is configured to be seated on a flat surface such as a counter or desktop. Personal assistant 104 is configured on a handheld device such as a smart phone.

In various embodiments, personal assistants are capable of disambiguating and clarifying verbal instructions in noisy environments. In various embodiments, when a personal assistant is in a noisy environment and a user attempts to provide a verbal instruction, the personal assistant is able to process the verbal instruction and/or the context associated with provision of the verbal instruction, and ascertain whether the verbal instruction was received intact or whether the noisy environment prevented some or all of the verbal instruction from being understood by the personal assistant. The personal assistant can perform this function in any suitable way. For example, in some embodiments, the personal assistant can monitor noise in the ambient environment and compare the monitored noise to a noise threshold. If the monitored noise exceeds a noise threshold, then the personal assistant knows that the environment has a noise property that may affect processing verbal commands. Alternately or additionally, the personal assistant can process the verbal instruction to ascertain the percentage of the instruction that was not clearly understood. If a certain percentage of the verbal instruction was not clearly understood, the personal assistant may wait until the monitored noise drops below the noise threshold to ask for clarification. That is, in an event that some or all of the verbal instruction was not understood by the personal assistant, the personal assistant is configured to wait until the noise in the environment abates to a level that is more suitable for fully understanding the verbal instruction. The personal assistant optionally provides a user-perceptible indication notifying the user that the environment is noisy or that the personal assistant is “paused” because of a noisy environment. When the noise abates, the personal assistant removes any such user-perceptible indication and can then ask for clarification by requesting, for example, that the user repeat the instruction.

In some instances, the context in which the verbal instruction is provided can be utilized to ascertain that an attempt was made to provide a verbal instruction, but such verbal instruction was not received intact. For example, many devices are equipped with cameras. These cameras can be used, in at least some embodiments, to ascertain that the user is attempting to issue a verbal instruction by speaking directly into the computing device. The camera may ascertain that the user's lips are moving so as to be speaking, but yet little or no audible verbal instruction was received by the personal assistant. In these instances and others, the verbal assistant can wait until the noise abates to ask for a clarification. The personal assistant optionally provides a user-perceptible indication notifying the user that the environment is noisy or that the personal assistant is “paused” because of a noisy environment. When the noise abates, the personal assistant removes any such user-perceptible indication and can then ask for clarification by requesting, for example, that the user repeat the instruction.

Environment 100 also includes a network 106, such as the Internet, and a voice services provider 108. In some instances, the personal assistant is configured to operate in both a local mode and a remote mode.

In the local mode, the personal assistant is able to locally process verbal instructions and locally execute local instructions without having to utilize voice services provider 108. For example, a user may request that the personal assistant open the device settings so that the user may adjust one or more of the settings. In this instance, the personal assistant may not necessarily need to engage the services of the voice services provider 108.

In the remote mode, the personal assistant may record and digitize the verbal instruction and send it to the voice services provider 108 by way of network 106. When the voice services provider 108 receives the digitized verbal instruction, the voice services provider 108 can parse the verbal instruction and execute the instruction accordingly. For example, a user may wish to discover all the pizza places within a 10 minute walk. When the user asks the personal assistant for this information, the assistant can record the verbal instruction, send the instruction to the voice services provider 108, and receive back from the voice services provider 108 a listing of pizza places that can be surfaced to the user.

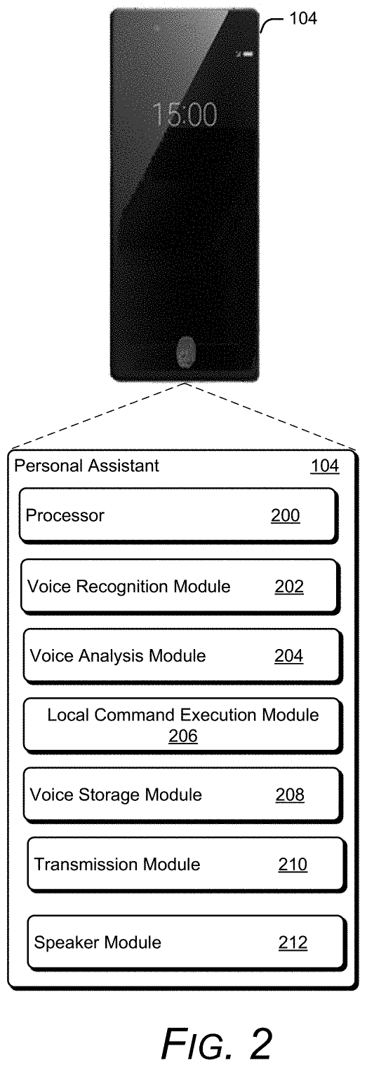

FIG. 2 illustrates personal assistant 104 in more detail in accordance with one or more embodiments. In this example, the personal assistant 104 includes one or more processors 200, a voice recognition module 202, a voice analysis module 204, a local command execution module 206, a voice storage module 208, a transmission module 210 and a speaker module 212.

Processor 200 can be implemented in connection with any suitable hardware, software, firmware, or combination thereof. Typically, the processor 200 executes machine-readable instructions to provide some type of functionality.

The voice recognition module 202 is representative of functionality that is utilized to recognize a particular user's voice and verbal cues that indicate that the user is attempting to provide verbal instructions. Such verbal cues can include a verbal invocation of the personal assistant. The voice recognition module thus recognizes a user's verbal instructions and enables the device to perform operations responsive to receiving verbal instructions from the user. The voice recognition module identifies words or instructions from audio input. For example, voice recognition module 202 can receive audio input from a microphone connected to, or included in the personal assistant. In turn, the voice recognition module 202 extracts or identifies audible words or instructions included within the audio input. Any suitable type of speech recognition algorithm and/or model can be used to identify the words or instructions, such as Hidden Markov models, dynamic time warping (DTW) based algorithms, neural networks, and so forth. In some embodiments, the voice recognition module includes training software to customize speech recognition algorithms to a particular voice. As one example, the training software can prompt a user to audibly state known words, and subsequently train on these known words to increase the reliability of their detection based on the user. In some embodiments, the voice recognition module can identify a particular word spoken by a particular user, such as a passcode audibly spoken by an authorized user. Accordingly, the voice recognition module 202 can identify words or instructions, as well as identify a particular user that audibly states the words or instructions. The voice recognition module 202 may also include noise analysis functionality to enable analysis of a particular environment's ambient noise level. The ambient noise analysis can then be used to ascertain whether the environmental ambient noise is above a particular threshold, as described above.

The voice analysis module 204 is representative of functionality that analyzes verbalizations on the part of the user. This can include analyzing verbalizations to ascertain whether a verbal instruction is being given. Furthermore, the voice analysis module 204 can process the verbalization to ascertain whether any such verbal instruction may be executed locally or remotely.

The local command execution module 206 is representative of functionality that enables verbal instructions to be executed locally on or by the device, without the need to engage remote voice services providers.

Voice storage module 208 is representative of functionality that records the verbal instruction provided by the user. This is useful when remote execution of the verbal instruction is needed. Accordingly, the voice storage module 208 stores the verbal instruction and the transmission module 210 can transmit the stored verbal instruction to a remote voice services provider for execution.

The speaker module 212 is representative of functionality that can provide the user with an audible response to any issued verbal instruction. This can include reading back search results and describing data that has been produced as a result of executing the verbal instruction.

The personal assistant may or may not include a display such as a touchscreen display as an input/output device. For instance, a user can enter input into personal assistant 104 by physically interacting with the display at various locations using finger(s) and/or a stylus. The user can also receive output from the personal assistant in the form of a visual display.

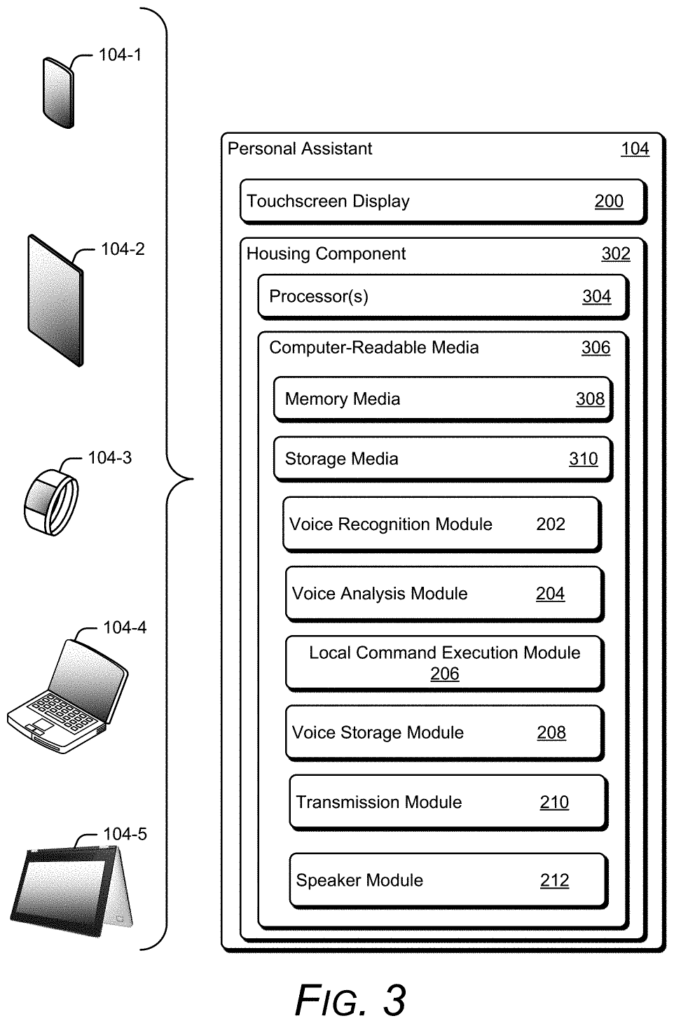

FIG. 3 illustrates an expanded view of personal assistant 104 of FIG. 1 as being implemented by various non-limiting example devices including: smartphone 104-1, tablet 104-2, smart watch 104-3, laptop 104-4, and convertible laptop 104-5. Accordingly, personal assistant 104 is representative of any suitable device that incorporates disambiguation and clarification functionality in noisy environments in a computing device, as described herein.

Personal assistant 104 includes housing component 302 to house or enclose various components within the personal assistant. Housing component 302 can be a single solid piece, or can be constructed from multiple pieces. The housing component can be constructed from any suitable material, such as metal, silicone, plastic, injection molded material, and so forth. In the cases where housing component 302 is constructed from multiple pieces, each piece can be of a same material, or can incorporate different materials from one another. Among other things, housing component 302 defines the boundaries or shape associated with personal assistant 104, such as, a top edge, a bottom edge, a right edge and a left edge in the case of a rectangular-shaped device, a circumference edge of a circular-shaped device, and so forth. To provide touch input for personal assistant 104, touchscreen display 200 is coupled with housing component 302 and/or various components residing within housing component 302.

Personal assistant 104 also includes processor(s) 304 and computer-readable media 306, which includes memory media 308 and storage media 310. Here, processors 304 and computer-readable media 306 reside within housing component 302. In some embodiments, processor(s) 304 include at least one application processor and at least one low power contextual processor. Applications and/or an operating system (not shown) embodied as computer-readable instructions on computer-readable media 306 are executable by processor(s) 304 to provide some, or all, of the functionalities described herein. For example, various embodiments can access an operating system module, which provides high-level access to underlying hardware functionality by obscuring implementation details from a calling program, such as protocol messaging, register configuration, memory access, and so forth.

Computer-readable media 306 includes voice recognition module 202, voice analysis module 204, local command execution module 206, voice storage module 208, transmission module 210, and speaker module 212 of FIG. 2. However, in alternate embodiments, varying combinations of these modules can be included and/or excluded. While these modules are illustrated here as residing on computer-readable media 306, they can alternately or additionally be implemented using hardware, firmware, software, or any combination thereof.

Having described an example operating environment in which various embodiments can be utilized, consider now a discussion of disambiguation and clarification for personal assistants in noisy environments.

### Disambiguation and Clarification for Personal Assistants in Noisy Environments

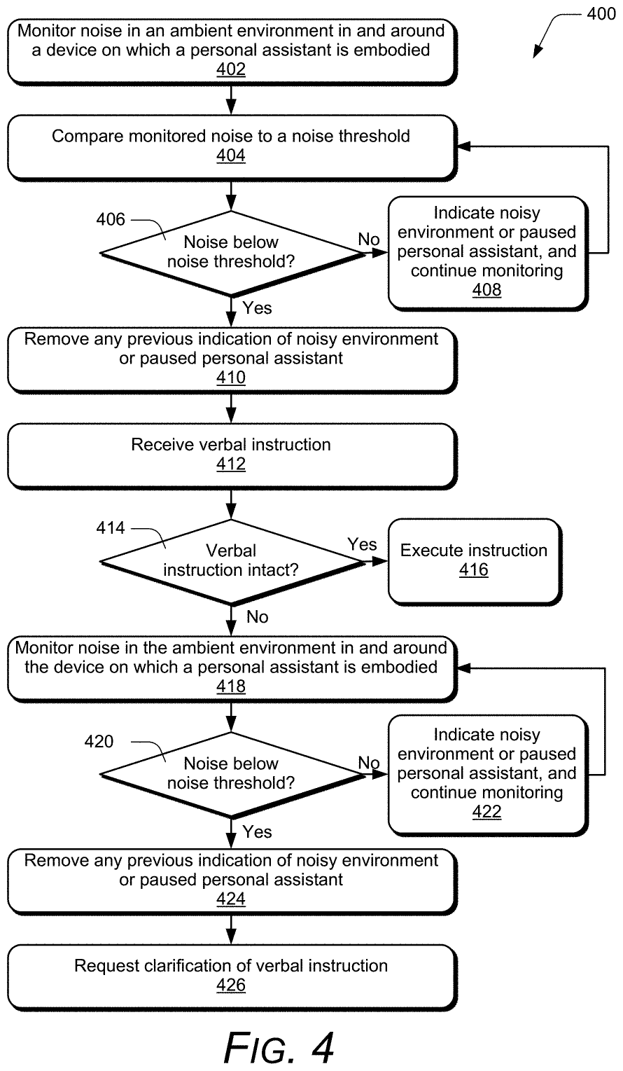

FIG. 4 illustrates an example method 400 that employs disambiguation and clarification functionality in accordance with one or more embodiments. Generally, any services, components, modules, methods, and/or operations described herein can be implemented using software, firmware, hardware (e.g., fixed logic circuitry), manual processing, or any combination thereof. For instance, portions or all of method 400 can be performed by varying combinations of the various modules described above. Some operations of the example methods may be described in the general context of executable instructions stored on computer-readable storage memory that is local and/or remote to a computer processing system, and implementations can include software applications, programs, functions, and the like. Alternately or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. While method 400 illustrates steps in a particular order, it is to be appreciated that any specific order or hierarchy of the steps described here is used to illustrate an example of a sample approach. Other approaches may be used that rearrange the ordering of these steps. Thus, the order of steps described here may be rearranged, and the illustrated ordering of these steps is not intended to be limiting.

At block 402, the personal assistant monitors noise in an ambient environment in and around the device on which the personal assistant is embodied. At block 404, the personal assistant compares the monitored noise to a noise threshold. Doing so sets a baseline around which the monitored noise can be compared for purposes which will be described below. At block 406, the personal assistant ascertains whether the noise in the ambient environment is below the noise threshold. If the noise in the ambient environment is not below the noise threshold, then at block 408, the personal assistant provides a user-perceptible indication notifying the user that the environment is noisy or that the personal assistant is “paused” because of a noisy environment, and continues to monitor the noise and returns to block 404.

If, on the other hand, the personal assistant determines, at block 406, that the noise in the ambient environment is below the noise threshold, at block 410 the personal assistant removes any previously provided user-perceptible indication that the environment is noisy or that the personal assistant is “paused”. At block 412, the personal assistant receives verbal instruction. This operation can be performed in any suitable way. At block 414, the personal assistant ascertains whether the verbal instruction is intact. This operation can be performed in any suitable way. For example, the personal assistant can process the verbal instruction to ascertain the percentage of instruction that was not clearly understood. Alternately or additionally, the personal assistant can contextually analyze the verbal instruction to see if it “makes sense.” For example, in a noisy environment, the personal assistant may have misinterpreted one or more words in the verbal instruction. To this extent, the verbal instruction may not make sense. If, at block 414, the verbal instruction was received intact, at block 416, the personal assistant can execute the verbal instruction. This act can be performed in various ways. For example, in a local mode, the personal assistant can execute the instruction locally on the device on which the personal assistant is embodied. Alternately or additionally, in a remote mode, the personal assistant can record the verbal instruction, send the recorded instruction to a remote voice services provider for execution, and receive back a response from the voice services provider and surface the response to the user. In this instance, surfacing the results from the voice services provider can be considered as “executing the verbal instruction.”

If, on the other hand, at block 414 the verbal instruction was not received intact, at block 418 the personal assistant can monitor the noise in the ambient environment in and around the device on which the personal assistant is embodied. At block 420, the personal assistant ascertains whether the noise in the ambient environment is below the noise threshold. If the noise in the ambient environment is not below the noise threshold, then at block 422, the personal assistant provides a user-perceptible indication notifying the user that the environment is noisy or that the personal assistant is “paused” because of a noisy environment, and continues to monitor the noise and returns to block 418. If, on the other hand, the personal assistant determines, at block 420, that the noise in the ambient environment is below the noise threshold, at block 424 the personal assistant removes any previously provided user-perceptible indication that the environment is noisy or that the personal assistant is “paused”. At block 426, the personal assistant requests clarification of the verbal instruction. This can be performed by audibly notifying the user that instruction was not fully understood and should be repeated.

In this manner, the personal assistant is able to disambiguate and clarify verbal instructions when such instructions are provided in a noisy environment. This ensures a higher probability that the personal assistant understands the verbal instruction accurately and completely.

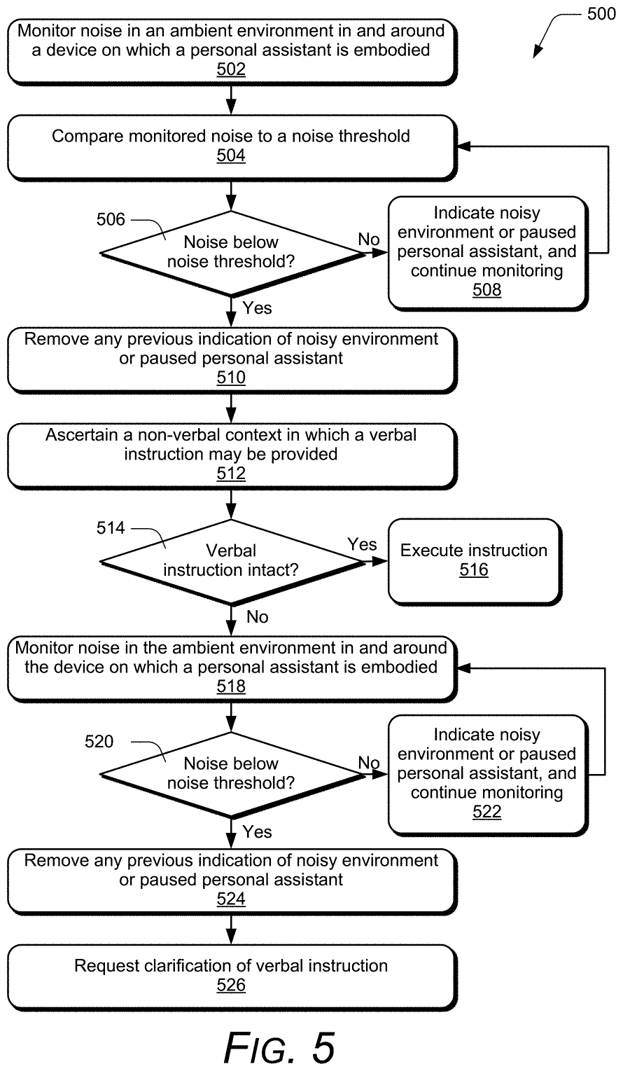

FIG. 5 illustrates an example method 500 that employs disambiguation and clarification in accordance with one or more embodiments. Generally, any services, components, modules, methods, and/or operations described herein can be implemented using software, firmware, hardware (e.g., fixed logic circuitry), manual processing, or any combination thereof. For instance, portions or all of method 500 can be performed by varying combinations of the various modules described above. Some operations of the example methods may be described in the general context of executable instructions stored on computer-readable storage memory that is local and/or remote to a computer processing system, and implementations can include software applications, programs, functions, and the like. Alternately or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. While method 500 illustrates steps in a particular order, it is to be appreciated that any specific order or hierarchy of the steps described here is used to illustrate an example of a sample approach. Other approaches may be used that rearrange the ordering of these steps. Thus, the order of steps described here may be rearranged, and the illustrated ordering of these steps is not intended to be limiting.

At block 502, the personal assistant monitors noise in an ambient environment in and around the device on which the personal assistant is embodied. At block 504, the personal assistant compares the monitored noise to a noise threshold. Doing this sets a baseline around which the monitored noise can be compared for purposes which will be described below. At block 506, the personal assistant ascertains whether the noise in the ambient environment is below the noise threshold. If the noise in the ambient environment is not below the noise threshold, then at block 508, the personal assistant provides a user-perceptible indication notifying the user that the environment is noisy or that the personal assistant is “paused” because of a noisy environment, and continues to monitor the noise and returns to block 504.

If, on the other hand, the personal assistant determines, at block 506, that the noise in the ambient environment is below the noise threshold, at block 510 the personal assistant removes any previously provided user-perceptible indication that the environment is noisy or that the personal assistant is “paused”. At block 512, the personal assistant ascertains a non-verbal context in which a verbal instruction may be provided. This operation can be performed in any suitable way. For example, in some embodiments, a camera on the device on which the personal assistant is embodied may be used to ascertain that the user is attempting to provide instructions by observing that the user's mouth is moving. In spite of the fact that the user's mouth is moving, the personal assistant may not be able to ascertain the verbal instruction because of the noise in the environment. Alternately or additionally, a non-verbal input associated with providing a verbal instruction may be provided to the device on which the personal assistant is embodied. Yet, because of the noisy environment, the verbal instruction following the non-verbal input was lost. Such non-verbal input can include, by way of example and not limitation, any suitable gesture (touch or non-touch), an input to a hardware button on the device, and the like.

At block 514, the personal assistant ascertains whether the verbal instruction is intact. This operation can be performed in any suitable way. For example, the personal assistant can process the verbal instruction to ascertain the percentage of instruction that was not clearly understood. Alternately or additionally, the personal assistant can contextually analyze the personal instruction to see if the verbal input “makes sense.” For example, in a noisy environment, the personal assistant may have misinterpreted one or more words in the verbal instruction. To this extent, the verbal instruction may not make sense. If, at block 514, the verbal instruction was received intact, at block 516, the personal assistant can execute the verbal instruction. This act can be performed in various ways. For example, in a local mode, the personal assistant can execute instructions locally on the device on which the personal assistant is embodied. Alternately or additionally, in a remote mode, the personal assistant can record the verbal instruction, send the recorded instruction to a remote voice services provider for execution, and receive back a response from the voice services provider and surface the response to the user. In this instance, surfacing the results from the voice services provider can be considered as “executing the verbal instruction.”

If, on the other hand, at block 514 the verbal instruction was not received intact, at block 518 the personal assistant can monitor the noise in the ambient environment in and around the device on which the personal assistant is embodied. At block 520, the personal assistant ascertains whether the noise in the ambient environment is below the noise threshold. If the noise in the ambient environment is not below the noise threshold, then at block 522, the personal assistant provides a user-perceptible indication notifying the user that the environment is noisy or that the personal assistant is “paused” because of the noisy environment, and continues to monitor the noise and returns to block 518. If, on the other hand, the personal assistant determines, at block 520, that the noise in the ambient environment is below the noise threshold, at block 524 the personal assistant removes any previously provided user-perceptible indication that the environment is noisy or that the personal assistant is “paused”. At block 526, the personal assistant requests clarification of the verbal instruction. This can be performed by audibly notifying the user that instruction was not fully understood and should be repeated.

In this manner, the personal assistant is able to disambiguate and clarify verbal instructions when such instructions are provided in a noisy environment. This ensures a higher probability that the personal assistant understands the verbal instruction accurately and completely.

### Perceptible Indications in a Personal Assistant

In some embodiments, the personal assistant is configured to provide one or more different user-perceptible indications associated with operating in a noisy environment. In some instances, a perceptible indication can indicate that the environment is, in fact, noisy. Such would allow the user to either wait until the perceptible indication is removed so that the verbal instruction can be provided or, alternately, find a quieter location in which to provide the verbal instruction.

Alternately or additionally, the personal assistant can be configured to provide a perceptible indication that can indicate that the personal assistant is “paused” because of the noisy environment. Again, this would allow the user to either wait until the perceptible indication is removed or, alternately, find a quieter location in which to provide the verbal instruction.

Perceptible indications can comprise any suitable indications that can convey information to the user. Such perceptible indications can include, by way of example and not limitation one or more lights such as LED lights, a visual display or message, an audible message, an alert tone, a flag, haptic feedback or any combination of these and other perceptible indications.

Having considered a discussion of disambiguation and clarification for personal assistants in noisy environments, consider now an example computing device that can implement the embodiments described above.

### Example Device

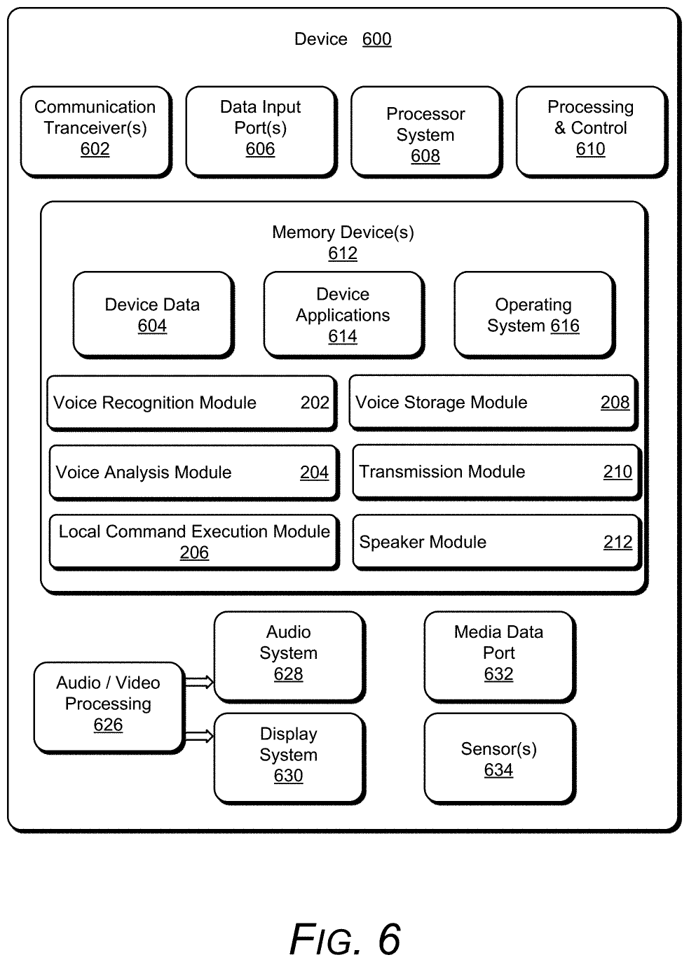

FIG. 6 illustrates various components of an example device 600 in which disambiguation and clarification for personal assistants in a noisy environment can be implemented. The example device 600 can be implemented as any suitable type of computing device, such as any type of mobile phone, tablet, computing, communication, entertainment, gaming, media playback, and/or other type of device.

The device 600 includes communication transceivers 602 that enable wired and/or wireless communication of device data 604 with other devices. Additionally, the device data can include any type of audio, video, and/or image data. Example transceivers include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.15 (WiMAX™) standards, and wired local area network (LAN) Ethernet transceivers for network data communication.

The device 600 may also include one or more data input ports 606 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones, cameras, and/or modular attachments.

The device 600 includes a processing system 608 of one or more processors (e.g., any of microprocessors, controllers, and the like) and/or a processor and memory system implemented as a system-on-chip (SoC) that processes computer-executable instructions. In some embodiments, processor system 608 includes a low power contextual processor and an application processor. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device can be implemented with any one or combination of software, hardware, firmware, or fixed logic circuitry that is implemented in connection with processing and control circuits, which are generally identified at 610. The device 600 may further include any type of a system bus or other data and command transfer system that couples the various components within the device. A system bus can include any one or combination of different bus structures and architectures, as well as control and data lines.

The device 600 also includes computer-readable storage memory or memory devices 612 that enable data storage, such as data storage devices that can be accessed by a computing device, and that provide persistent storage of data and executable instructions (e.g., software applications, programs, functions, and the like). Examples of the computer-readable storage memory or memory devices 612 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 600 may also include a mass storage media device.

The computer-readable storage memory provides data storage mechanisms to store the device data 604, other types of information and/or data, and various device applications 614 (e.g., software applications). For example, an operating system 616 can be maintained as software instructions with a memory device and executed by the processing system 608. The device applications may also include a device manager, such as any form of a control application, software application, signal-processing and control module, code that is native to a particular device, a hardware abstraction layer for a particular device, and so on. In this example, the device 600 includes a voice recognition module 202, a voice analysis module 204, a local command execution module 206, a voice storage module 208, a transmission module 210 and a speaker module 212, as described above.

The device 600 also includes an audio and/or video processing system 626 that generates audio data for an audio system 628 and/or generates display data for a display system 630.

The audio system 628 and/or the display system 630 may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 632. In implementations, the audio system and/or the display system are integrated components of the example device. Alternatively, the audio system and/or the display system are external, peripheral components to the example device.

Device 600 also includes sensor(s) 634 that can be used to detect motion of, or around, device 600. Sensors(s) 634 can also include audio sensors to detect or receive audio input to device 600. In some embodiments, sensor(s) 634 provide input to other modules to facilitate their functionality. Alternately or additionally, sensors 634 can include haptic sensors that are configured to provide haptic feedback.

### Conclusion

Various embodiments enable disambiguation and clarification for personal assistants in noisy environments. In various embodiments, when a personal assistant is in a noisy environment and a user attempts to provide a verbal instruction, the personal assistant is able to process the verbal instruction and/or the context associated with provision of the verbal instruction, and ascertain whether the verbal instruction was received intact or whether the noisy environment prevented some or all of the verbal instruction from being understood by the personal assistant. In an event that some or all of the verbal instruction was not understood by the personal assistant, the personal assistant is configured wait until the noise in the environment abates to a level that is more suitable for fully understanding the verbal instruction. When the noise abates, the personal assistant can then ask for clarification by requesting, for example, that the user repeat the instruction.

Although various embodiments have been described in language specific to features and/or methods, the subject of the appended claims is not necessarily limited to the specific features or methods described. Rather, the specific features and methods are disclosed as example implementations, and other equivalent features and methods are intended to be within the scope of the appended claims. Further, various different embodiments are described and it is to be appreciated that each described embodiment can be implemented independently or in connection with one or more other described embodiments.

We claim:

1. A computing device comprising:
one or more processors; and
one or more computer-readable storage devices storing processing-executable instructions which, responsive to execution by the one or more processors, cause the computing device to perform operations comprising:
receiving, by a personal assistant embodied on the computing device, a verbal instruction;
ascertaining, by the personal assistant, whether the verbal instruction is intact;
responsive to the verbal instruction not being received intact, monitoring noise in an ambient environment around the computing device; and
responsive to the noise in the ambient environment being below a noise threshold, requesting clarification of the verbal instruction.

2. The computing device as recited in claim 1, wherein said ascertaining is performed by processing the verbal instruction to ascertain a percentage of the instruction that was not clearly understood.

3. The computing device as recited in claim 1, wherein said ascertaining comprises contextually analyzing the verbal instruction.

4. The computing device as recited in claim 1, wherein said ascertaining comprises analyzing the verbal instruction to ascertain whether one or more words have been misinterpreted.

5. The computing device as recited in claim 1, further comprising after said requesting, and responsive to the verbal instruction being received intact, executing the verbal instruction.

6. The computing device as recited in claim 5, wherein said executing the verbal instruction comprises executing the verbal instruction locally on the computing device.

7. The computing device as recited in claim 5, wherein said executing the verbal instruction comprises sending the verbal instruction to a remote voice services provider and receiving back a response from the voice services provider that may be surfaced to the user.

8. The computing device as recited in claim 1 further comprising providing a user-perceptible indication indicating that the ambient environment is noisy.

9. The computing device as recited in claim 1 further comprising providing a user-perceptible indication indicating that the personal assistant is paused because of a noisy ambient environment.

10. A computer-implemented method comprising:
ascertaining, by a personal assistant embodied on a computing device, a non-verbal context in which a verbal instruction may be provided by a user;
ascertaining, by the personal assistant, whether the verbal instruction is intact;
responsive to the verbal instruction not being received intact, monitoring noise in the ambient environment; and
responsive to the noise in the ambient environment being below a noise threshold, requesting clarification of the verbal instruction.

11. The computer-implemented method of claim 10, wherein said ascertaining comprises using a camera on the computing device to ascertain that the user is attempting to provide instructions.

12. The computer-implemented method of claim 10, wherein the non-verbal context comprises a non-verbal input to the computing device associated with providing a verbal instruction.

13. The computer-implemented method of claim 10, wherein said ascertaining is performed by processing the verbal instruction to ascertain a percentage of the instruction that was not clearly understood.

14. The computer-implemented method of claim 10, wherein said ascertaining comprises contextually analyzing the verbal instruction.

15. The computer-implemented method of claim 10, wherein said ascertaining comprises analyzing the verbal instruction to ascertain whether one or more words have been misinterpreted.

16. The computer-implemented method of claim 10, further comprising after said requesting, and responsive to the verbal instruction being received intact, executing the verbal instruction.

17. The computer-implemented method of claim 16, wherein said executing the verbal instruction comprises executing the verbal instruction locally on the computing device.

18. The computer-implemented method of claim 16, wherein said executing the verbal instruction comprises sending the verbal instruction to a remote voice services provider and receiving back a response from the voice services provider that may be surfaced to the user.

19. The computer-implemented method of claim 10 further comprising providing a user-perceptible indication indicating that the ambient environment is noisy.

20. The computer-implemented method of claim 10 further comprising providing a user-perceptible indication indicating that the personal assistant is paused because of a noisy ambient environment.
